(19) United States
(12) Patent Application Publication
(10) Pub. No.: US 2024/0280370 A1
(43) Pub. Date: Aug. 22, 2024

(54) TRAFFIC SIMULATION DEVICE, TRAFFIC SIMULATION METHOD, AND TRAFFIC SIMULATION PROGRAM

(71) Applicant: NIPPON TELEGRAPH AND TELEPHONE CORPORATION, Tokyo (JP)

(72) Inventors: Masaru TAKAGI, Musashino-shi, Tokyo (JP); Kenji KOMIYA, Musashino-shi, Tokyo (JP); Atsushi ISOMURA, Musashino-shi, Tokyo (JP)

(73) Assignee: NIPPON TELEGRAPH AND TELEPHONE CORPORATION, Tokyo (JP)

(21) Appl. No.: 18/567,787

(22) PCT Filed: Jun. 11, 2021
(86) PCT No.: PCT/JP2021/022412

§ 371 Date: Dec. 7, 2023

(51) Int. Cl. G01C 21/34; G01C 21/36

(52) U.S. Cl. CPC G01C 21/3492; G01C 21/3694

(57) ABSTRACT

The acquisition unit acquires a plurality of predetermined points in a target area and a predetermined probability distribution regarding the plurality of points. The definition unit defines, with a predetermined probability distribution, a plurality of routes each having each of a plurality of predetermined points in the target area as a departure place or a destination.

### TECHNICAL FIELD

The present invention relates to a traffic simulation device, a traffic simulation method, and a traffic simulation program.

### BACKGROUND ART

Conventionally, simulation techniques related to traffic are known (refer to Patent Literatures 1 and 2). In a simulation technique related to traffic, when a specific calculation target area is specified, specification of departure places/destinations of a plurality of vehicles at a calculation start time point has been restricted. For example, setting work of individually specifying the departure place/destination for each of all the plurality of vehicles requires a lot of labor. Therefore, the departure place/destination is specified by rounding the arrangement places of the plurality of vehicles at the calculation start time point to a representative point or randomly selecting an arrangement place in the specified area.

Alternatively, a target area of simulation is limited in order to avoid a restriction of a calculation amount for specifying a departure place/destination of each vehicle, and in a case where at least one of the departure place or the destination is far away and not located in the target area, a point in the target area in the same direction is substituted for the departure place or the destination outside the target area.

### CITATION LIST

### Patent Literature

Patent Literature 1: JP 2020-160960 A
Patent Literature 2: JP 2009-259158 A

### SUMMARY OF INVENTION

### Technical Problem

However, according to the prior art, it has been difficult to perform a simulation related to traffic in accordance with the actual situation. For example, when the arrangement places of the plurality of vehicles are rounded to the representative point, the number of arrangement places of the plurality of vehicles is small at the calculation start time point, and the deviation from the actual arrangement places and arrangement number of vehicles is large.

Moreover, calculation not based on an actual traveling route is performed by substituting the departure place or the destination outside the target area with a point in a direction of the departure place or the destination instead of a specific position in the target area.

The present invention has been made in view of the above, and an object thereof is to perform a simulation related to traffic in accordance with the actual situation.

### Solution to Problem

In order to solve the above-described problems and achieve the object, a traffic simulation device according to the present invention includes: an acquisition unit that acquires a plurality of predetermined points in a target area and a predetermined probability distribution regarding the plurality of points; and a definition unit that defines, with a predetermined probability distribution, a plurality of routes each having each of the plurality of predetermined points in the target area as a departure place or a destination.

### Advantageous Effects of Invention

According to the present invention, it is possible to perform a simulation related to traffic in accordance with the actual situation.

### BRIEF DESCRIPTION OF DRAWINGS

FIG. 1 is a diagram for explaining an outline of a traffic simulation device according to a first embodiment.

FIG. 2 is a schematic diagram illustrating a schematic configuration of a traffic simulation device according to the first embodiment.

FIG. 3 is a flowchart illustrating a traffic simulation processing procedure according to the first embodiment.

FIG. 4 is a diagram for explaining an outline of a traffic simulation device according to a second embodiment.

FIG. 5 is a schematic diagram illustrating a schematic configuration of a traffic simulation device according to the second embodiment.

FIG. 6 is a flowchart illustrating a traffic simulation processing procedure according to the second embodiment.

FIG. 7 is a diagram illustrating an example of a computer that executes a traffic simulation program.

### DESCRIPTION OF EMBODIMENTS

Hereinafter, an embodiment of the present invention will be described in detail with reference to the drawings. Note that the present invention is not limited by the embodiment. Moreover, the same parts are denoted by the same reference signs in the description of the drawings.

### First Embodiment

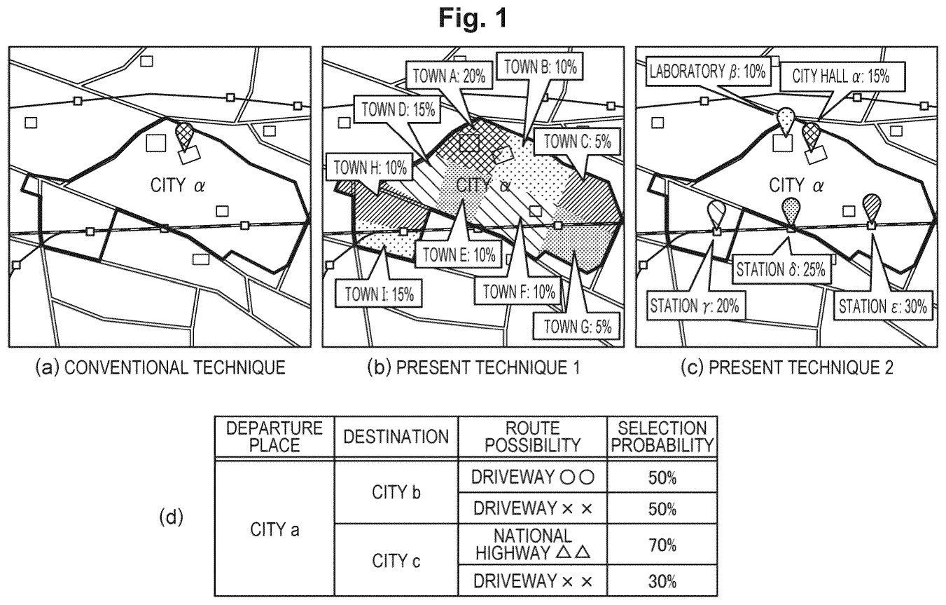

FIG. 1 is a diagram for explaining an outline of a traffic simulation device according to the first embodiment. Conventionally, in specifying a departure place/destination and performing a simulation (which will be hereinafter referred to as a traffic simulation) related to traffic such as a traffic condition of a vehicle, the area is divided into calculable areas and a route (passing point) is defined in each area in a case where a distance between the departure place and the destination is long.

Here, in a case where a departure place or a destination is ambiguously specified in a municipal unit or an area unit, a plurality of departure places/destinations of vehicles in each area is conventionally rounded to a representative point such as a municipal office or a central point of the area as illustrated in FIG. 1(a). Therefore, at the calculation start time point, the number of arrangement places of the plurality of vehicles is small, and the deviation from the actual arrangement places and arrangement number of vehicles is large.

On the other hand, a traffic simulation device of the present embodiment defines a plurality of route possibilities with a probability distribution by defining a plurality of points with a probability distribution instead of rounding the departure places or the destinations to a representative point in each area.

For example, as illustrated in FIG. 1(b), a plurality of points are defined by allocating a vehicle to each region in an area on the basis of the distribution of residential areas of users of vehicles. Alternatively, as illustrated in FIG. 1(c), a plurality of points are defined by allocating a vehicle to each facility such as a station or a city hall in an area according to point of interest (POI) information and the scale of facilities.

Moreover, as for a route, a plurality of route possibilities is similarly defined with a probability distribution as illustrated in FIG. 1(d). As described above, the traffic simulation device can define a route possibility based on the actual situation and perform a traffic simulation for the defined route possibility.

### [Configuration of Traffic Simulation Device]

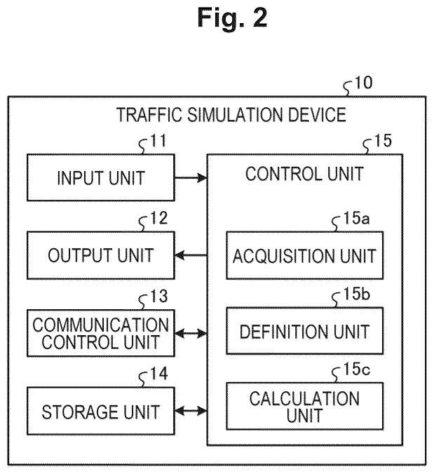

FIG. 2 is a schematic diagram illustrating a schematic configuration of a traffic simulation device according to the first embodiment. As illustrated in FIG. 2, a traffic simulation device 10 of the present embodiment is implemented by a general-purpose computer such as a personal computer, and includes an input unit 11, an output unit 12, a communication control unit 13, a storage unit 14, and a control unit 15.

The input unit 11 is implemented by an input device such as a keyboard or a mouse and inputs various types of instruction information, such as processing start, to the control unit 15 in response to an input operation by an operator. The output unit 12 is implemented by a display device such as a liquid crystal display, a printer, or the like. For example, the output unit 12 displays a result of traffic simulation processing to be described later.

The communication control unit 13 is implemented by a network interface card (NIC) or the like, and controls communication between an external device and the control unit 15 via a telecommunication line such as a local area network (LAN) or the Internet. For example, the communication control unit 13 controls communication between the control unit 15 and a management device or the like that manages map data and various types of information such as PoI information, facility information, and population distribution in an area to be processed.

The storage unit 14 is implemented by a semiconductor memory element such as a random access memory (RAM) or a flash memory, or a storage device such as a hard disk or an optical disk. In the storage unit 14, a processing program for operating the traffic simulation device 10, data used during execution of the processing program, and the like are stored in advance or temporarily stored each time of processing. Note that the storage unit 14 may be configured to communicate with the control unit 15 via the communication control unit 13. Moreover, the storage unit 14 may acquire and store in advance various types of information necessary for traffic simulation processing to be described later, such as map data, POI information in an area to be processed, facility information, and a population distribution.

The control unit 15 is implemented by a central processing unit (CPU) or the like and executes a processing program stored in a memory. In this manner, the control unit 15 functions as an acquisition unit 15a, a definition unit 15b, and a calculation unit 15c as illustrated in FIG. 2. Note that each or some of these functional units may be implemented in different hardware. Moreover, the control unit 15 may include other functional units.

The acquisition unit 15a acquires a plurality of predetermined points in the target area and a predetermined probability distribution regarding the plurality of points. For example, the acquisition unit 15a acquires PoI information regarding the inside of the target area on the map and information indicating the scale of each facility. Alternatively, the acquisition unit 15a acquires a population distribution of a plurality of regions in the target area. The acquisition unit 15a acquires the information via the input unit 11, or from a management device or the like via the communication control unit 13. The acquisition unit 15a may store the acquired information in the storage unit 14.

Moreover, the acquisition unit 15a acquires the number of vehicles flowing into a target area required for processing by the calculation unit 15c to be described later.

The definition unit 15b defines, with a predetermined probability distribution, a plurality of routes each having each of a plurality of predetermined points in the target area as a departure place or a destination. For example, the definition unit 15b defines a plurality of routes each having each of a plurality of regions as a departure place or a destination by defining the presence of a vehicle with a probability distribution according to a population distribution of the plurality of regions in the target area as illustrated in FIG. 1(b).

In the example illustrated in FIG. 1(b), a route through which a vehicle passes in each region is defined with a probability distribution according to the population distribution of each of town A, town B, . . . in the target area. This is effective when, for example, a departure place or the home (destination) of each vehicle can be preliminarily grasped at a municipal level.

Note that the definition unit 15b also can similarly define a plurality of routes by using a distribution of the number of owned vehicles instead of the population distribution. Moreover, the target area is not limited to a municipal unit, and may be a ward unit, a town unit, a block unit, or a mesh unit of several meters in an urban area. Moreover, the definition unit 15b may adjust the probability distribution with reference to congestion data of the day by, for example, setting the selection probability of a route in which congestion occurs to be relatively low.

Alternatively, the definition unit 15b defines a plurality of routes each having each of the plurality of facilities as a departure place or a destination by defining the presence of a vehicle with a probability distribution according to the scale of a plurality of predetermined facilities in the target area as illustrated in FIG. 1(c). In the example illustrated in FIG. 1(c), a route through which a vehicle passes in each facility is defined with a probability distribution according to the scale of each of a plurality of facilities such as city hall α, laboratory β, and station γ in a target area.

The definition unit 15b may output a plurality of defined routes. For example, prior to the processing of the calculation unit 15c to be described later, a plurality of routes may be defined and stored in the storage unit 14. Alternatively, the definition unit 15b may immediately transfer the plurality of defined routes to the calculation unit 15c to be described later, without storing the plurality of defined routes in the storage unit 14. Alternatively, the definition unit 15b may output the plurality of defined routes to the output unit 12, or to another device via the communication control unit 13.

Moreover, the definition unit 15b may define and output a plurality of routes in the target area with a probability distribution that is each selected by the vehicle, as illustrated in FIG. 1(d). In the example illustrated in FIG. 1(d), for example, two routes of driveway OO and driveway XX are defined as a route from departure place city “a” to destination city “b” with a probability distribution of 50%. The definition unit 15b may output a plurality of defined routes.

The calculation unit 15c performs a traffic simulation for a plurality of defined routes. For example, the calculation unit 15c distributes the number of vehicles flowing into the target area acquired by the acquisition unit 15a to a plurality of defined routes according to each probability distribution. This result indicates a congestion situation in the target area. In this manner, the calculation unit 15c derives the congestion situation in the target area and outputs the congestion situation via the output unit 12 or the communication control unit 13.

### [Traffic Simulation Processing]

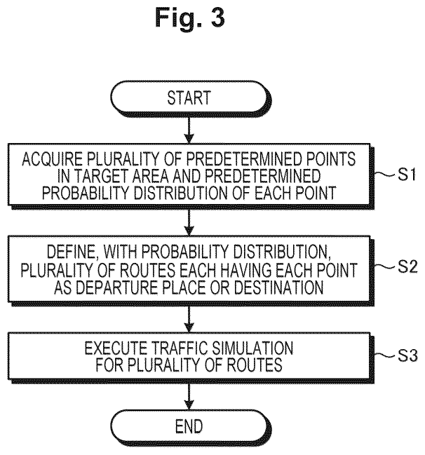

Next, traffic simulation processing by the traffic simulation device 10 according to the first embodiment will be described with reference to FIG. 3. FIG. 3 is a flowchart illustrating a traffic simulation processing procedure according to the first embodiment. The flowchart of FIG. 3 is started at, for example, a timing when the user performs an operation input instructing start.

First, the acquisition unit 15a acquires a plurality of predetermined points in the target area, and a predetermined probability distribution of the plurality of points (step S1). For example, the acquisition unit 15a acquires PoI information regarding the inside of the target area on the map and information indicating the scale of each facility. Alternatively, the acquisition unit 15a acquires a population distribution of a plurality of regions in the target area.

Next, the definition unit 15b defines, with a predetermined probability distribution, a plurality of routes each having each of a plurality of predetermined points in the target area as a departure place or a destination (step S2). For example, the definition unit 15b defines a plurality of routes each having each of the plurality of regions as a departure place or a destination by defining the presence of a vehicle with a probability distribution according to the population distribution of a plurality of regions in the target area.

Alternatively, the definition unit 15b defines a plurality of routes each having each of the plurality of facilities as a departure place or a destination by defining the presence of a vehicle with a probability distribution according to the scale of a plurality of predetermined facilities in the target area.

Moreover, the calculation unit 15c executes a traffic simulation for a plurality of defined routes (step S3). For example, the calculation unit 15c distributes the number of vehicles flowing into the target area acquired by the acquisition unit 15a to a plurality of defined routes according to respective probability distributions, and outputs the number to the output unit 12 or the like as a congestion situation. In this manner, a series of traffic simulation processing ends.

### Second Embodiment

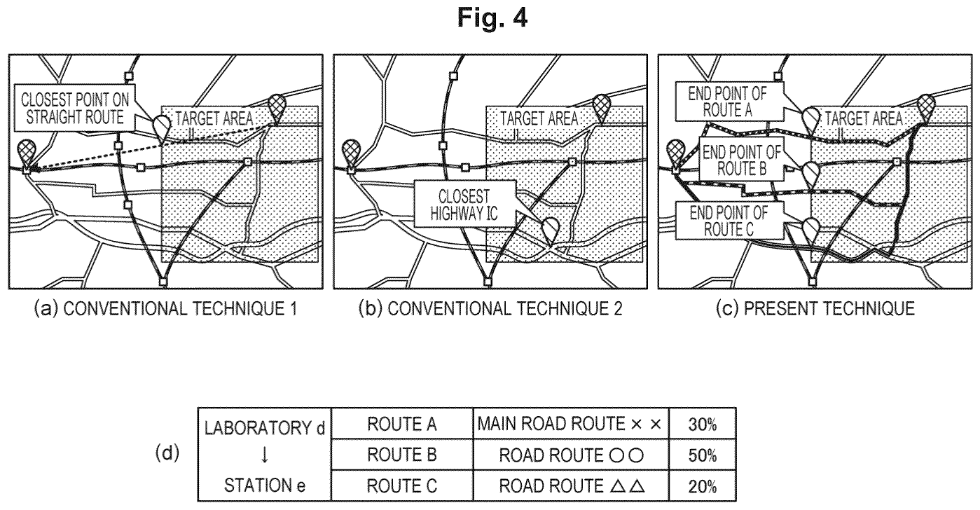

FIG. 4 is a diagram for explaining an outline of a traffic simulation device according to a second embodiment. In a conventional traffic simulation, in a case where a given departure place or destination is outside a target area of the traffic simulation as illustrated in FIGS. 4(a) and 4(b), a point in the target area in a direction of the departure place or the destination is substituted. For example, in the example illustrated in FIG. 4(a), a point in the target area closest to the departure place or the destination on a straight route from the departure place or a straight route to the destination is substituted. Alternatively, in the example illustrated in FIG. 4(b), a closest highway interchange (IC) is substituted.

On the other hand, a traffic simulation device 10a of the present embodiment roughly estimates a route from a departure place or a route to a destination, and defines the route by substituting an end point that can be seen from a target area on each route. In this manner, the traffic simulation device can define a route based on the actual situation and perform traffic simulation for the defined route.

### [Configuration of Traffic Simulation Device]

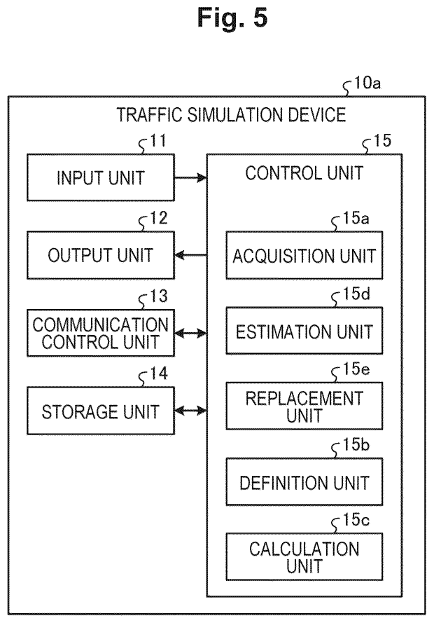

FIG. 5 is a schematic diagram illustrating a schematic configuration of a traffic simulation device according to the second embodiment. The traffic simulation device 10a illustrated in FIG. 5 is different from the traffic simulation device 10 of the first embodiment illustrated in FIG. 2 in including an estimation unit 15d and a replacement unit 15e. Explanation on other functional units similar to those of the traffic simulation device 10 illustrated in FIG. 2 will be omitted.

An acquisition unit 15a acquires a departure place or a destination outside a target area. Similarly to the first embodiment, the acquisition unit 15a acquires the number of vehicles flowing into the target area.

The estimation unit 15d estimates a route extending from the acquired departure place or destination through the target area. For example, the estimation unit 15d uses a known route search algorithm to estimate a rough route extending through the target area including a section outside the target area.

The replacement unit 15e replaces the acquired departure place or destination with an end point of the target area on the estimated route. For example, the replacement unit 15e replaces the departure place or the destination with an end point that can be seen from the target area on the estimated route as illustrated in FIG. 4(c).

Note that, in a case where the estimated route extends through a highway, the replacement unit 15e may set an entrance of the highway as an end point of the target area. Moreover, the replacement unit 15e may output the replaced end point. That is, the replacement unit 15e may store the route defined by replacement with the end point in a storage unit 14 prior to the processing of a calculation unit 15c to be described later. Alternatively, the replacement unit 15e may immediately transfer the defined route to the calculation unit 15c to be described later, without storing the defined route in the storage unit 14. Alternatively, the replacement unit 15e may output the defined route to an output unit 12, or to another device via a communication control unit 13.

FIG. 4(c) illustrates a case where the estimation unit 15d estimates a plurality of routes A to C. In this case, the replacement unit 15e sets each end point of the target area corresponding to each route as the departure place or the destination of the area.

As described above, in a case where the estimation unit 15d estimates a plurality of routes, a definition unit 15b defines the plurality of routes with a probability distribution according to the utilization (selection) rate of a vehicle of each route, similarly to the first embodiment as illustrated in FIG. 4(d). In the example illustrated in FIG. 4(d), three routes A to C from the departure place laboratory “d” to the destination station “e” are defined with probability distributions according to the utilization rate of a vehicle of each route.

Moreover, the calculation unit 15c performs a traffic simulation of a congestion situation or the like for the route defined in this manner as in the first embodiment.

### [Traffic Simulation Processing]

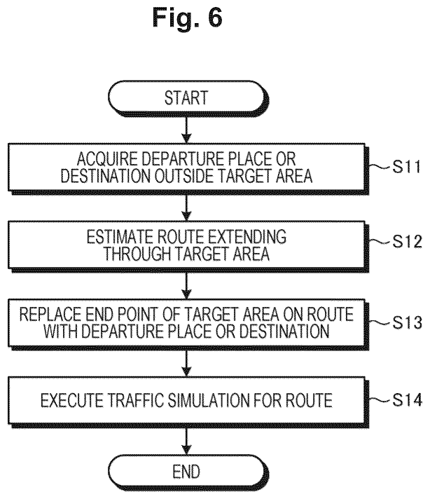

Next, traffic simulation processing by the traffic simulation device 10a according to the second embodiment will be described with reference to FIG. 6. FIG. 6 is a flowchart illustrating a traffic simulation processing procedure according to the second embodiment. The flowchart of FIG. 6 is started at, for example, a timing when the user performs an operation input instructing start.

First, the acquisition unit 15a acquires a departure place or a destination outside the target area (step S11). Next, the estimation unit 15d estimates a route extending from the acquired departure place or destination through the target area (step S12). For example, the estimation unit 15d uses a known route search algorithm to estimate a rough route extending through the target area including a section outside the target area.

Then, the replacement unit 15e replaces the acquired departure place or destination with an end point of the target area on the estimated route (step S13). For example, the replacement unit 15e replaces the departure place or the destination with an end point that can be seen from the target area on the estimated route. In this manner, the replacement unit 15e defines a route in the target area.

Finally, the calculation unit 15c executes a traffic simulation of a congestion situation or the like for the defined route (step S14). In this manner, a series of traffic simulation processing ends.

As described above, in the traffic simulation device 10 of the present embodiment, the acquisition unit 15a acquires a plurality of predetermined points in the target area and a predetermined probability distribution regarding the plurality of points. Moreover, the definition unit 15b defines, with a predetermined probability distribution, a plurality of routes each having each of a plurality of predetermined points in the target area as a departure place or a destination.

For example, the definition unit 15b defines a plurality of routes each having each of the plurality of regions as a departure place or a destination by defining the presence of a vehicle with a probability distribution according to the population distribution of a plurality of regions in the target area. Alternatively, the definition unit 15b defines a plurality of routes each having each of the plurality of facilities as a departure place or a destination by defining the presence of a vehicle with a probability distribution according to the scale of a plurality of predetermined facilities in the target area.

In this manner, it is defined that there is a vehicle on a route with a larger probability as the population is larger or the scale of a facility is larger. As described above, the traffic simulation device 10 can define a route based on the actual situation by defining the presence of a vehicle in accordance with the actual situation.

Here, in a route search algorithm such as a conventional car navigation system, a clear point within a range of a map is specified as a destination. Moreover, in a case where the destination is specified as an area, the area is rounded to a representative point such as a city hall and processed. Moreover, although route possibilities are presented according to a search condition, it is assumed that the route possibilities are finally narrowed down to one. Moreover, the same route is allocated to a plurality of vehicles when the search conditions are the same. Moreover, a route search is performed on demand after a departure place and a destination become clear.

On the other hand, in the traffic simulation device 10, the destination is not limited to within the range of the map, and it is also possible to specify an ambiguous point in a municipal unit or the like as the destination. Moreover, in a case where a destination is specified as an area, the destination is stochastically set according to the population distribution or the like in the area. Moreover, a plurality of route possibilities are held together with the selection probability of each route. Moreover, different routes are allocated to vehicles according to the selection probability. Moreover, a route can be preliminarily defined for a small number of combinations of a departure place and a destination. Accordingly, it is possible with the traffic simulation device 10 to perform a simulation related to traffic with high accuracy in accordance with the actual situation, since the presence of a vehicle is defined in accordance with the actual situation and a route based on the actual situation is defined.

Moreover, the definition unit 12b outputs a plurality of defined routes. This makes it possible to disperse the processing load by preliminarily performing processing before executing the traffic simulation.

Moreover, the definition unit 12b defines and outputs a plurality of routes in the target area with a probability distribution that is each selected by the vehicle. This also makes it possible to define a route based on the actual situation.

Moreover, the acquisition unit 15a further acquires a departure place or a destination outside the target area. Moreover, the estimation unit 15d estimates a route extending from the acquired departure place or destination through the target area. Moreover, the replacement unit 15e replaces the acquired departure place or destination with an end point of the target area on the estimated route. In this manner, the traffic simulation device 10 can define a route based on the actual situation and execute a simulation related to traffic with high accuracy.

### [Program]

It is also possible to create a program in which processes to be executed by the traffic simulation device 10 or 10a according to the above embodiment are described in a computer-executable language. As an embodiment, the traffic simulation device 10 or 10a can be implemented by causing a desired computer to install a traffic simulation program that executes the above-described traffic simulation processing as package software or online software. For example, it is possible to cause an information processing device to function as the traffic simulation device 10 or 10a by causing the information processing device to execute the above traffic simulation program. The information processing device mentioned here includes a desktop or notebook personal computer. In addition, the information processing device also includes a mobile communication terminal such as a smartphone, a mobile phone, or a personal handyphone system (PHS), a slate terminal such as a personal digital assistant (PDA), and the like. Moreover, the functions of the traffic simulation devices 10 and 10a may be implemented in a cloud server.

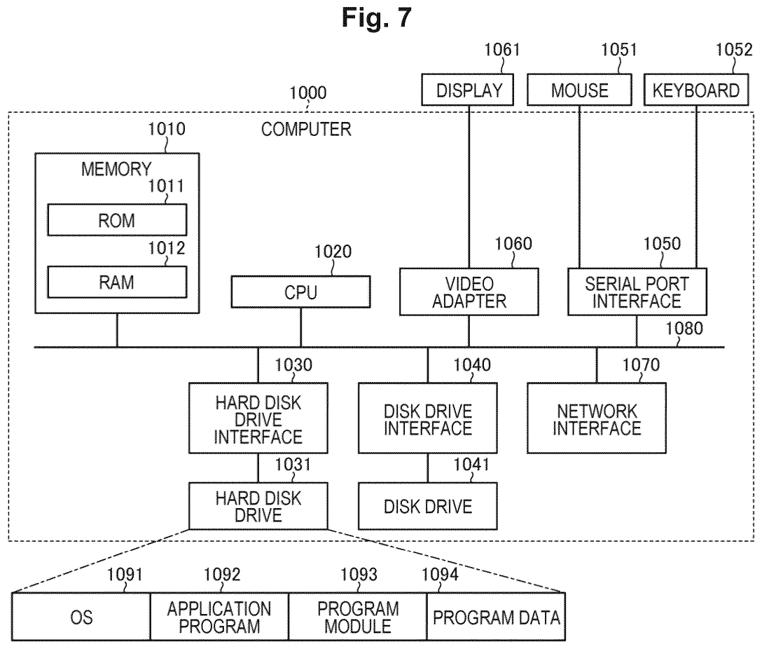

FIG. 7 is a diagram illustrating an example of a computer that executes a traffic simulation program. A computer 1000 includes, for example, a memory 1010, a CPU 1020, a hard disk drive interface 1030, a disk drive interface 1040, a serial port interface 1050, a video adapter 1060, and a network interface 1070. These units are connected with each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected with a hard disk drive 1031. The disk drive interface 1040 is connected with a disk drive 1041. For example, a removable storage medium such as a magnetic disk or an optical disk is inserted into the disk drive 1041. The serial port interface 1050 is connected with, for example, a mouse 1051 and a keyboard 1052. The video adapter 1060 is connected with, for example, a display 1061.

Here, the hard disk drive 1031 stores, for example, an OS 1091, an application program 1092, a program module 1093, and program data 1094. The information described in the above embodiments is stored in, for example, the hard disk drive 1031 or the memory 1010.

Moreover, the traffic simulation program is stored in the hard disk drive 1031 as a program module 1093 in which commands to be executed by the computer 1000 are described, for example. Specifically, the program module 1093 in which each process to be executed by the traffic simulation device 10 described in the above embodiment is described is stored in the hard disk drive 1031.

Moreover, data used for information processing by the traffic simulation program is stored in, for example, the hard disk drive 1031 as the program data 1094. Then, the CPU 1020 reads, into the RAM 1012, the program module 1093 and the program data 1094 stored in the hard disk drive 1031 as necessary and executes each procedure described above.

Note that the program module 1093 and the program data 1094 related to the traffic simulation program are not limited to being stored in the hard disk drive 1031, and may be stored in, for example, a removable storage medium and read by the CPU 1020 via the disk drive 1041 or the like. Alternatively, the program module 1093 and the program data 1094 related to the traffic simulation program may be stored in another computer connected via a network such as a LAN or a wide area network (WAN) and read by the CPU 1020 via the network interface 1070.

Although the embodiments to which the invention made by the present inventor is applied have been described above, the present invention is not limited by the description and drawings constituting a part of the disclosure of the present invention according to the embodiments. In other words, other embodiments, examples, operational technologies, and the like made by those skilled in the art and the like on the basis of the embodiments are all included in the scope of the present invention.

### REFERENCE SIGNS LIST

10, 10a Traffic simulation device
11 Input unit
12 Output unit
13 Communication control unit
14 Storage unit
15 Control unit
15a Acquisition unit
15b Definition unit
15c Calculation unit
15d Estimation unit
15e Replacement unit

1. A traffic simulation device comprising:
acquisition circuitry that acquires a plurality of predetermined points in a target area and a predetermined probability distribution regarding the plurality of points; and
definition circuitry that defines, with a predetermined probability distribution, a plurality of routes each having each of the plurality of predetermined points in the target area as a departure place or a destination.

2. The traffic simulation device according to claim 1, wherein;
the definition circuitry defines a plurality of routes each having each of a plurality of regions as a departure place or a destination by defining presence of a vehicle with a probability distribution according to a population distribution of the plurality of regions in the target area.

3. The traffic simulation device according to claim 1, wherein:
the definition circuitry defines a plurality of routes each having each of a plurality of predetermined facilities as a departure place or a destination by defining presence of a vehicle with a probability distribution according to scale of the plurality of predetermined facilities in the target area.

4. The traffic simulation device according to claim 1, wherein:
the definition circuitry outputs the plurality of defined routes.

5. The traffic simulation device according to claim 1, wherein:
the definition circuitry defines and outputs a plurality of routes in the target area with a probability distribution that is each selected by a vehicle.

6. The traffic simulation device according to claim 1, wherein:
the acquisition circuitry further acquires a departure place or a destination outside the target area, and
the traffic simulation device further comprises:
estimation circuitry that estimates a route having the target area as a departure place or a destination from the acquired departure place or destination; and
replacement circuitry that replaces the acquired departure place or destination with an end point of the target area on the estimated route.

7. A traffic simulation method, comprising:
acquiring a plurality of predetermined points in a target area and a predetermined probability distribution regarding the plurality of points; and
defining, with a predetermined probability distribution, a plurality of routes each having each of a plurality of predetermined points in the target area as a departure place or a destination.

8. A non-transitory computer readable medium storing a traffic simulation program for causing a computer to execute:
acquiring a plurality of predetermined points in a target area and a predetermined probability distribution regarding the plurality of points; and
defining, with a predetermined probability distribution, a plurality of routes each having each of a plurality of predetermined points in the target area as a departure place or a destination.
